(19) United States
(12) Patent Application Publication
(10) Pub. No.: US 2007/0156686 A1
(43) Pub. Date: Jul. 5, 2007

(54) Method and apparatus for searching data in a mobile communication terminal

(75) Inventors: Jae-Hwan Kim, Suwon-si (KR); Se-Ho Chang, Suwon-si (KR); Myong-Gyu Kim, Suwon-si (KR); Joo-Kyung Woo, Seoul (KR); Ja-Yeon Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd.

(21) Appl. No.: 11/643,482

(22) Filed: Dec. 21, 2006

(30) Foreign Application Priority Data
Dec. 23, 2005 (KR) 2005-0128339

(51) Int. Cl. G06F 7/00

(52) U.S. Cl. 707/7

(57) ABSTRACT

The present invention relates to a method and an apparatus for searching a phone book in a mobile communication terminal utilizing visual spatial information of data in the phonebook. In the method, address book data is grouped by an initial character of a name or number stored in the phone book when selecting a bubble search menu. The grouped characters are represented as a bubble. When a bubble is selected, the selected bubble is zoomed in, and a character corresponding to the selected bubble is displayed and input.

### PRIORITY

This application claims priority under 35 U.S.C. § 119 to an application entitled “Method For Searching Phone Book In A Portable Terminal” filed in the Korean Intellectual Property Office on Dec. 23, 2005 and assigned Serial No. 2005-128339, the contents of which are incorporated herein by reference.

### BACKGROUND OF THE INVENTION

1. Field of the Invention

The present invention relates to a method and an apparatus for searching data; for example a phone book, using visual spatial information in a mobile communication terminal.

2. Description of the Related Art

Due to the portability of mobile communication terminals and the resulting widespread use of them, service providers and terminal manufacturers have been developing more convenient and special features to attract more users. For example, a mobile communication terminal is now equipped with the functions of a phonebook, games, a scheduler, a Short Message Service (SMS), the Internet, e-mail, morning or wake-up call, MPEG Layer 3 (MP3) players and a digital camera.

The mobile communication terminal can input and store a number of telephone numbers and names corresponding to the telephone numbers using the phone book function. Telephone numbers stored in the phone book can be searched and displayed on a LCD display window by a user's manipulation. The user can also call searched telephone numbers.

A detailed description on searching a telephone number is as follows. A mobile communication terminal displays a search menu of phone book on a display unit by a user's key input. If a name list or a phone book search item is selected in the search menu of the phone book, the mobile communication terminal converts into an input mode and receives a search word.

Next, if the search word is input, the mobile communication terminal searches a corresponding name in a memory, outputs a search result by a list on the display unit and selects a telephone number in the list, and thereby it can find a telephone number corresponding to the name. Further, the mobile communication terminal can provide detailed information on the searched name by filtering data matching procedure according to the user's selection.

However, conventional telephone number searching is oriented to a function rather than visual effect on a display when searching. Also, because a changed searched set is displayed immediately on the bottom of the display unit whenever an additional key input generates the changed search, the user may feel the conventional telephone number searching is bothersome because of frequent screen transition according to key inputs. Therefore, as far as aesthetic satisfaction is concerned, an improved searching method is needed.

Also, two to four characters are mapped to one key and therefore key manipulation for inputting a name to be searched involves a troublesome process in conventional telephone number searching. Therefore, improved technology is necessary to provide for simpler searching.

### SUMMARY OF THE INVENTION

Accordingly, an object of the present invention is to provide an improved and efficient visual method and apparatus for searching a phone book in a mobile communication terminal.

Another object of the present invention is to provide a method and an apparatus for searching a telephone number using visual spatial information of data to be searched.

Another object of the present invention is to provide a method and an apparatus for searching a telephone number using a bubble size method and a grouping of search results through a bubble selecting process.

According to one aspect of the present invention for achieving the above objects, in a method for searching data in a mobile communication terminal, the method includes arranging a predetermined number of grouped data in a database as bubbles on a display unit, selecting a bubble, displaying a character corresponding to the selected bubble on a input window of the display unit, and displaying a data list including the input character.

According to another aspect of the present invention for achieving the above objects, in a method of for searching data in a mobile communication terminal, the method includes arranging a predetermined number of grouped data in a database as bubbles on a display unit, selecting a bubble, zooming-in the selected bubble, displaying sub bubbles forming the bubble and arranging the sub bubbles on the zoomed-in bubble, selecting a sub bubble, zooming-in the selected sub bubble and displaying a character corresponding to the selected sub bubble on a character input window of the display unit, and displaying a data list including the input character.

According to still another aspect of the present invention for achieving the above objects, a mobile communication terminal includes memory means for including a database storing data, a controller for searching data, a bubble processor for arranging a predetermined number of searched grouped data in a database as bubbles on a display menas, selecting a bubble, outputting a character corresponding to the selected bubble on a input window of the display means, and outputting a data list including the input character, and the display means for displaying the character corresponding to the selected bubble on a input window and displaying the data list including the input character.

According to still another aspect of the present invention for achieving the above objects, a mobile communication terminal includes memory means for including a database storing data, a controller for controlling a bubble processor; the bubble processor, controlled under the controller, for searching data, arranging a predetermined number of searched grouped data in a database as bubbles on a display means, selecting a bubble, outputting a character corresponding to the selected bubble on a input window of the display means, and outputting a data list including the input character, and the display means for displaying the character corresponding to the selected bubble on a input window and displaying the data list including the input character.

### BRIEF DESCRIPTION OF THE DRAWINGS

The above and other objects, features, and advantages of the present invention will become more apparent from the following detailed description when taken in conjunction with the accompanying drawings in which:

FIG. 1 is a block diagram of a mobile communication terminal according to the present invention;

FIG. 2 is a flowchart illustrating a procedure of searching a phone book of a mobile communication terminal according to the present invention;

FIG. 3A, FIG. 3B and FIG. 3C are illustrations showing bubble elements and display method thereof in a mobile communication terminal according to the present invention;

FIG. 4A, FIG. 4B, FIG. 4C and FIG. 4D are illustrations showing a method of providing corresponding amount of information according to a result of phone book search in a mobile communication terminal according to the present invention;

FIG 5A, FIG. 5B, FIG. 5C, FIG. 5D, FIG. 5E, FIG. 5F, FIG. 5G and FIG. 5H are illustrations showing a process of phone book search in a mobile communication terminal according to the present invention; and

FIG. 6A and FIG. 6B are illustrations showing a configuration of a screen layout for a bubble phone book search in a mobile communication terminal according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail not to obscure the present invention unnecessarily.

Hereinafter, a method and an apparatus for searching data, for example a phone book, in a mobile communication terminal will be described.

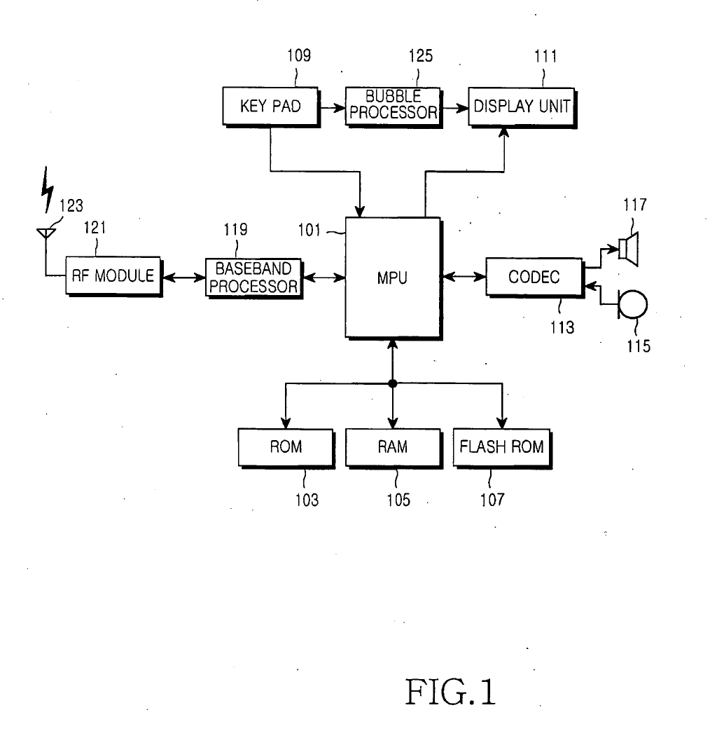

FIG. 1 is a block diagram of a mobile communication terminal according to the present invention. The mobile communication terminal includes, but not limited to, a cellular phone, a Personal Communication System (PCS), a Personal Data Assistant (PDA) and International Mobile Telecommunication-2000 (IMT2000) terminal. Hereinafter, a general function configuration of the above examples will be described.

Referring to FIG. 1, a Micro-Processor Unit (MPU), acting as a controller, 101 controls an overall operation of the mobile communication terminal. For example, the MPU 101 is responsible for processing and controlling voice communication and data communication. In addition, the MPU 101 controls a bubble processor 125 in processing a function for searching a phone book using visual spatial information. A detailed description of the typical processing and controlling operation of the MPU 101 will not be described.

A memory is provided that can include, but is not limited to, Read Only Memory (ROM) 103, Random Access Memory (RAM) 105 and flash RAM 107. ROM 103 stores software for processing and controlling the MPU 101 and all reference data, and, in particular, for searching a phone book using visual spatial information. RAM 105, which is a working memory of the MPU, stores temporary data being generated while executing all software. Flash RAM 107 has a file system and stores various updatable data to be kept such as a phone book. In particular, the flash RAM 107 stores a searching number of the phone book or amount of address book data.

A key pad 109 includes numeral keys of digits 0-9 and a plurality of function keys, such as a MENU key, a CANCEL (REMOVE) key, an ENTER key, a TALK key, an END key, an Internet connection key and navigation (or directional) keys (▴/▾/ [symbol] / [symbol] ). The key input data corresponding to a key pressed by the user is transmitted to the MPU 101. Also, the key pad 109 provides the bubble processor 125 with key input data mapped to the selected bubble when sensing a bubble selection by the user.

A display unit 111 displays status information, a number of characters, moving pictures, still pictures and the like. The display unit 111 may be a Liquid Crystal Display (LCD).

A Coder-Decoder (CODEC) 113 connected to the MPU 101, a microphone 115, and a speaker 117 connected to the CODEC are audio input/output blocks for use in voice communication. The MPU 101 produces PCM (Pulse Code Modulation) data and the CODEC 113 converts the PCM data into analog audio signals. The analog audio signals are outputted through the speaker 117. Also, the CODEC 113 converts analog audio signals received through the microphone 115 into PCM data and provides the MPU 101 to the PCM data.

Radio Frequency (RF) unit 121 drops a frequency of an RF signal received through an antenna 123 and provides the RF signal to a baseband processor 119. Also, the RF unit 121 increases a frequency of a baseband signal provided from the baseband processor 119, transmits the baseband signals through the antenna 123.

The baseband processor 119 processes the baseband signals which are transmitted/received between the RF unit 121 and the MPU 101. For example, for data transmission, the baseband processor 119 performs channel coding and spreading transmitting data. For data reception, the baseband processor 119 performs despreading and channel decoding for reception data.

The bubble processor 125 performs a bubble processing under the control of MPU 101. The bubble processor 125 calculates a number of data for each key representing a character group using a result of searching a phone book database by the MPU 101 according to user's selection. The bubble processor itself may search a phone book database and calculate the number of data. And the bubble processor 125 forms a screen layout by determining a bubble size for each key according to corresponding number of data. The bubbles are mapped to separate keys so as to spatially interact with key matrix of the keypad 109. Also, the bubble processor 125 receives key input from the key pad 109 and performs zoom-in or zoom-out function according to the key input.

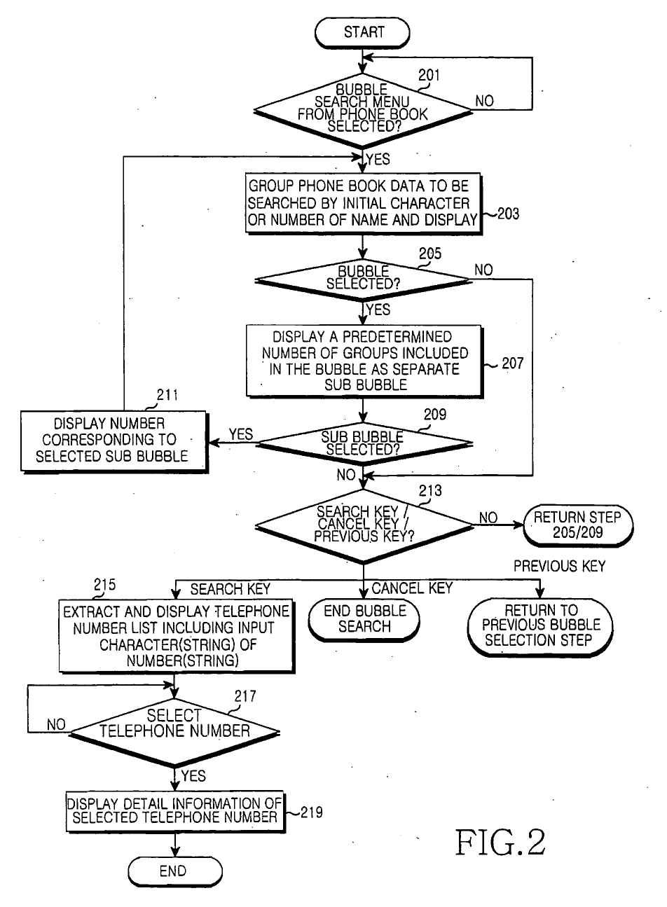

FIG. 2 is a flowchart illustrating a procedure of searching a phone book of a mobile communication terminal according to the present invention. Referring to FIG. 2, the MPU 101 checks whether a bubble search menu is selected by a user's key input.

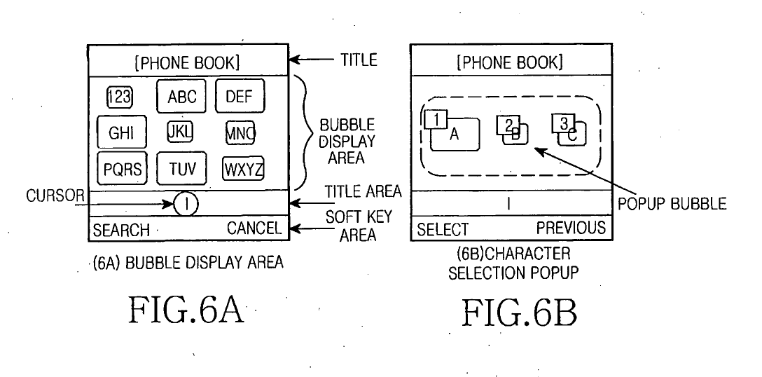

When the bubble search menu is selected, the MPU 101 proceeds to step 203 to group address book data according to an initial character of name or a number stored in the address book data, and expresses predetermined numbers of initial characters or numbers with a shape of bubble, that are arranged on the display unit 111, and thereby form a screen layout. Here, the screen layout includes title area, bubble display area, name display area and soft key area, as shown in FIG. 6A. The bubbles arranged on the screen layout are mapped to keys of the key pad 109 so as to facilitate key interaction. The arrangement of bubbles may the same as that of key map, for example, numeric keys of digits 0-9, and the location of the bubble is the same as that of a certain key. For example, ‘GHI’ bubble represents a bubble mapped to key number 4 by grouping ‘G’, ‘H’ and ‘I’ characters in key number 4 area. The size of area of the bubble may be proportional to amount of address book data grouped by the character or number.

Here, the number of bubbles arranged on the screen layout is re-adjusted according to the circumstances of the portable terminal including a method of key interaction. For example, if A to Z are represented as separate bubbles, key interaction is limited and it is difficult to display so many bubbles together in the limited area of the display unit of portable terminal. Thus, in the present invention, a method of grouping a predetermined number of alphabet letters and mapping them to the key matrix is used.

A size of the bubble may also be determined by a frequency of selection of corresponding character or by user selection.

After this, the MPU 101 checks whether there is a bubble selection according to the user's key input in step 205. When the bubble selection is not sensed, the MPU 101 proceeds to step 213 to check whether a search key, a cancel key or a previous key is input.

When the bubble selection is sensed, the MPU 101 proceeds to step 207 to display a popup window enlarging the selected bubble on the display unit 111 and arrange a number of elements in the selected bubble as a sub bubble under the selected bubble in the popup window as shown in FIG. 6B. Here a character also may be used as a sub bubble.

Next, the MPU 101 checks whether there is a sub bubble selection according to the user's input in step 209. When the sub bubble selection is sensed, the MPU 101 proceeds to step 211 to display a number corresponding to the selected sub bubble in an input window of the display unit 111.

Also, the MPU 101 limits the address book data to the selected sub bubble data. After this, the MPU 101 returns to step 203 to group the address book data by an initial character of a name or a number stored in the address book data in a search range reduced by the limitation. The predetermined number of the characters or numbers is expressed by a bubble shape or arranged bubble position on the display unit 111.

For example, when the bubble selected in the screen layout is ‘ABC’, sub bubbles ‘A’, ‘B’ and ‘C’ are displayed in the popup window enlarging the selected bubble. When selecting ‘A’ sub bubble, the MPU 101 displays ‘A’ in the input window. Here, if the address book data grouped by ‘A’ is ‘Adam’, ‘Adrian’, ‘Ai’, ‘Ake’, ‘Aliana’, ‘Alice’, ‘Andres’, ‘Anders’, ‘Anja’ and ‘Anke’, the MPU 101 regroups the address book data grouped by ‘A’ by ‘d’, ‘i’, ‘k’, ‘l’ and ‘n’ connected to ‘A’, and a user selects the grouped data. Thus, the number of names to be selected can be reduced and more efficiently extracted.

If a bubble selection is not sensed in step 209, the MPU 101 checks whether a search key, a cancel key or a previous key is input in step 213. If the search key, the cancel key or the previous key is not input, the MPU 101 returns to step 205 or step 209. In other words, if the search key, the cancel key or the previous key is not input in step 213 after step 205, the MPU 101 returns to step 205. If the search key/cancel key/previous key is not input in step 213 after step 209, the MPU 101 returns to step 209. If the cancel key is input, the MPU 101 ends the bubble search. If the previous key is input, the MPU 101 returns to a previous bubble selection step.

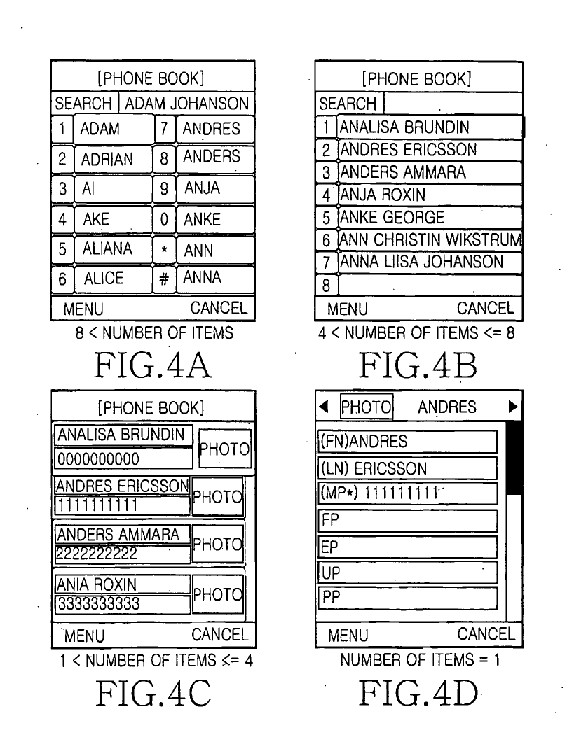

If the search key input is sensed, the MPU 101 proceeds to step 215 to extract a list of telephone numbers including the input character (string) or number (string) from a database in flash RAM 107. The list of telephone numbers is displayed on the display unit 111. Here, the list of telephone numbers displayed on the display unit 111 can provide not equally visible information but an optimum variable layout according to amount of the searched data, as shown in FIG. 4 A, B, C and D. That is, an optimum view according to the number of address book entries corresponding to an alphabet inputted by the user can be provided.

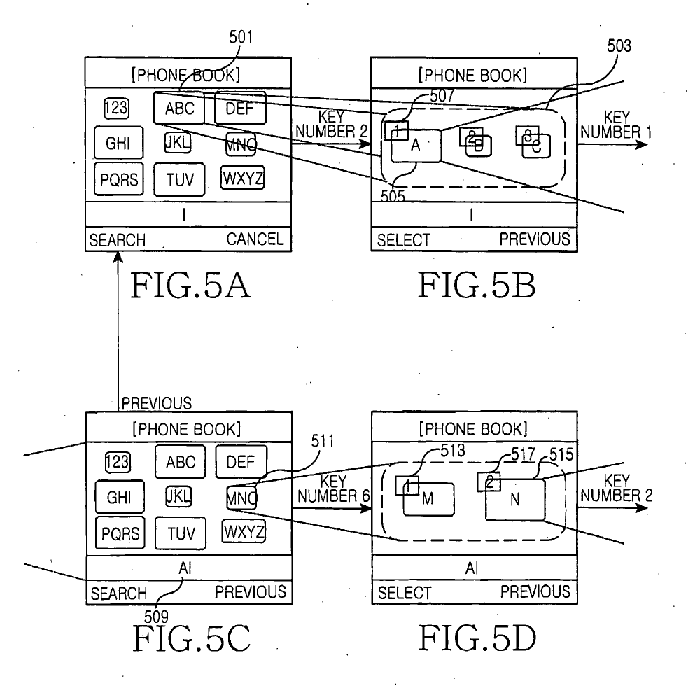

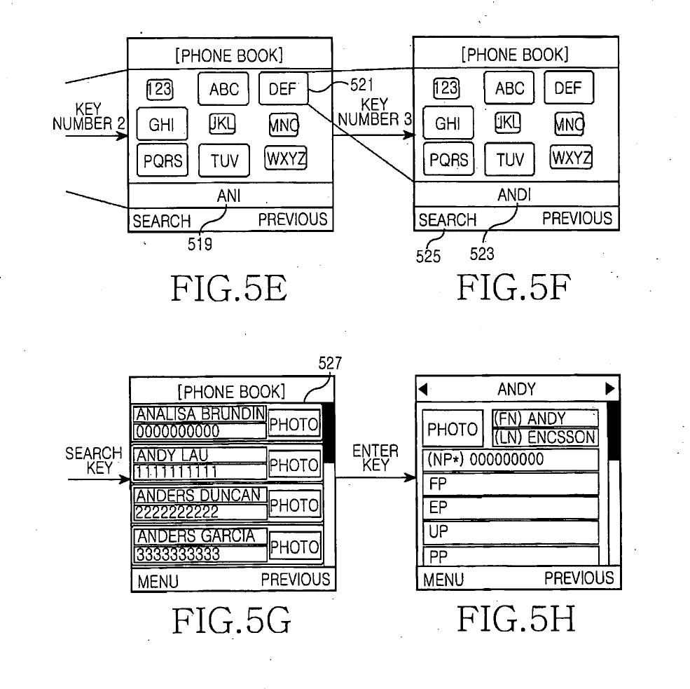

Next, the MPU 101 checks whether a telephone number is selected from the telephone number list according to user's key input in step 217. If the telephone number is not selected, another selection attempt is performed. If a telephone number is selected, detailed information of the selected telephone number is displayed on the display unit 111, as in FIG. 5G. After this, the MPU 101 ends the algorithm.

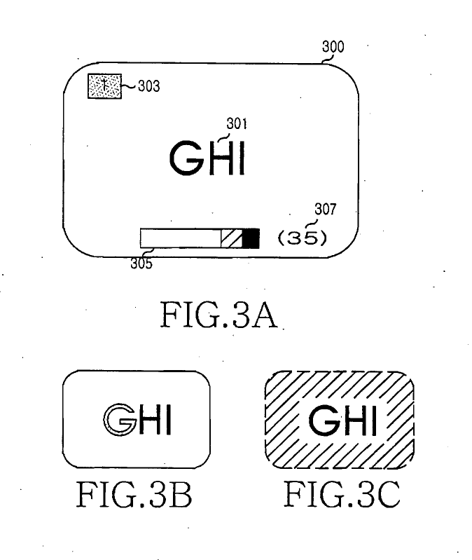

FIG. 3A, FIG. 3B and FIG. 3C are illustrations showing bubble elements and display method thereof in a mobile communication terminal according to the present invention.

Referring to FIG. 3A, a bubble 300 includes a character group 301, an assigned key value 303, a graph 305 indicating data amount for a corresponding character and a total number of data 307. The character group 301 is a group of the character or number being represented by the bubble 300. Also, the assigned key value 303 indicates interaction of the bubble and key map and can be displayed by pressing a predetermined key, e.g., ‘*’. The graph 305 indicates amount of address book data grouped by the character or number. The total number of data 307 is a total number of address book data. The graph 305 and the total number of data 307 are displayed by pressing a predetermined key, e.g., ‘#’. Here, ‘*’ and ‘#’, which are not used in key mapping of 3*3 bubble, are displayed only with user's key input, thereby reducing Graphic User Interface (GUI) complexity and improving graphic effect.

Here, the existence of address book data corresponding to the bubble can be represented by a different text color, a different background color or by a specific pattern. For example, the existence of each address book data for character or number can represented by setting a character or number with a color different from a color of the other characters in the represented character group 301, as shown in FIG. 3B (here, ‘G’ has a different color). The existence of each address book data for the total of represent character group 301 is represented by setting a background of corresponding bubble with a different color, as shown in FIG. 3C (here, background has a different color). A character or bubble being not included in data is inactivate or is not displayed so as not to react to user's input. Thus, it can reduce unnecessary information.

FIG. 4A, FIG. 4B, FIG. 4C and FIG. 4D are illustrations showing a method of providing corresponding amount of information according to a result of phone book search in a mobile communication terminal according to the present invention. That is, FIGS. 4 A, B and C illustrate examples of screen displaying according to a number of searched data in FIG. 5G. If the number of searched address book data is more than eight, information displayed on the display unit 111 can include only first name information of names stored in a corresponding phone book, as in FIG. 4A. Also, if the number of searched address book data is more than four but less than eight, information displayed on the display unit 111 can include last name along with first name stored in a corresponding phone book, as in FIG. 4B. If the number of searched address book data is more than one but less than four, information displayed on the display unit 111 can include a name, a telephone number and a photo stored in a corresponding phone book, as in FIG. 4C. Finally, if the number of searched address book data is just one, the MPU 101 can directly display detailed information of corresponding data, as in FIG. 4D.

FIG. 5A, FIG. 5B, FIG. 5C, FIG. 5D, FIG. 5E, FIG. 5F, FIG. 5G and FIG. 5H are illustrations showing a process of phone book search in a mobile communication terminal according to the present invention. Hereinafter, a telephone number stored with a name ‘Andy’ will be described as an example.

Referring to FIGS. 5A-H, an initial bubble screen FIG. 5A formed according to selection of user's bubble search menu includes a 3*3 bubble layout and a character input window. The bubbles of ‘123’, ‘ABC’, ‘DEF’, ‘GHI’, ‘JKL’, ‘MNO’, ‘PQRS’, ‘TUV’ and ‘WXYZ’ are arranged in the bubble layout. The bubbles are separately mapped to numeric keys of digits 0-9. The user can confirm a key value mapped to each bubble by inputting ‘*’ key and can select a bubble by inputting the key value. At this time, if there is no data for a corresponding character, the character mapped to the bubble may be changed to gray color or may not be displayed, thereby reducing unnecessary information.

To input ‘A’ of ‘Andy’ on the character input window, the user selects ‘ABC’ bubble 501 in the bubble layout. Here, ‘ABC’ bubble 501 has been mapped to a key number 2 and can be selected by pressing the key number 2. The selected ‘ABC’ bubble 501 is zoomed in and displayed in the middle of screen using a popup window 503, FIG. 5B. Sub bubbles of ‘A’ 505, ‘B’, and ‘C’ are displayed in the popup window 503. At this time, the user selects ‘A’ sub bubble 505 by inputting a key value 507 of ‘A’ sub bubble 505, and thereby ‘A’ of ‘Andy’ can be input in the character input window 509.

After this, the popup window 503 is closed and the initial bubble screen as in FIG. 5C is displayed. A bubble arranged on the initial bubble screen in FIG. 5C in which ‘A’ sub bubble 505 is zoomed in comprises of grouping address book data included in ‘A’ sub bubble 505 by a character or a number connected to ‘A’. At this time, the selected ‘A’ is displayed in the character input window 509.

Next, to input ‘n’ of ‘Andy’, the user selects ‘MNO’ bubble 511 in the bubble screen FIG. 5C and ‘N’ sub bubble 515 in a popup window 513 displayed in FIG. 5D according to selection of ‘MNO’ bubble 511. Thereafter, FIG. 5E is displayed and ‘An’ is displayed in character input window 519 in FIG. 5E. Here, if ‘MNO’ bubble 511 include only record for ‘M’ and ‘N’, only ‘M’ and ‘N’ sub bubbles are displayed in the popup window 513 in FIG. 5D.

Next, to input ‘d’ of ‘Andy’, the user selects ‘EDF’ bubble 521 from a bubble layout of the screen FIG. 5E. Here, if ‘DEF’ bubble 521 includes only records for ‘D’, FIG. 5F does not display a popup bubble window in order to reduce user interaction. Thus, ‘And’ 523 is input in the character input window of the screen as in FIG. 5F.

Here, the user may search the name by inputting more characters according to the above procedure. The user may alternatively search the name using the input name so far. In other words, the inputted name ‘And’ 523 can be searched by pressing a left soft key 525 for searching in the present screen. If a name list shown as in FIG. 5G having an initial character of ‘And’ 523 is searched, the user selects ‘Andy’ 527 from the first item, presses an Enter key, and thereby the user can confirm detailed information of ‘Andy’. If a name having an initial character of ‘And’ is the only corresponding record, detailed information about ‘Andy’ shown as in FIG. 5H is directly displayed without displaying the search result as in FIG. 5G. Thus, it is possible to reduce unnecessary process. Here, a previous key in screens or popup windows is a key for moving to a previous screen.

Also, bubbles may be selected by using navigation keys and an Enter key as well as inputting keys mapped to bubbles. For example, when selecting the bubble search menu, the user moves a first focus of the character input window to the bubble layout using the navigation keys, selects a bubble using the navigation keys in the bubble layout, inputs the Enter key with the bubble, and thereby can display sub bubbles. At this time, the user selects a sub bubble using the navigation keys, inputs the Enter key with the bubble, and thereby can input a search character.

FIG. 6A and FIG. 6B are illustrations showing a configuration of a screen layout for a bubble phone book search in a mobile communication terminal according to the present invention.

Here, the screen layout includes title area, bubble display area, name display area and soft key area, as shown in FIG. 6A. As described before, the bubbles arranged on the screen layout are mapped to keys of the key pad 109. For example, ‘GHI’ bubble represents a bubble mapped to key number 4 by grouping ‘G’, ‘H’ and ‘I’ characters in key number 4 area. The size of area of the bubble may be proportional to amount of address book data grouped by the character or number.

The elements in the selected bubble expressed as a sub bubble under the selected bubble in the popup window, as shown in FIG. 6B. Here a character also may be used as a sub bubble.

In the present invention, the user can try to search a phone book by directly inputting text. That is, if the user inputs text using a key pad, information of address book data corresponding to the input text is highlighted in the bubble layout. The user can search the phone book by selecting information and pressing the Enter key.

As described above, the present invention provides a method and apparatus for searching a phone book using visual spatial information of phone book data. Thus, a user can confirm an amount of information schematically. The present invention provides similar method to search a telephone dictionary in alphabet sequence. Also, it provides visual spatial interaction and sensible satisfaction to a user.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for searching data in a mobile communication terminal, comprising the steps of:
arranging a predetermined number of grouped data in a database as bubbles for display on a display unit;
selecting a bubble;
displaying a character corresponding to the selected bubble on an input window of the display unit; and
displaying a data list including the input character.

2. The method of claim 1, wherein the step of selecting the bubble includes enlarging a bubble and displaying the enlarged bubble in a popup window.

3. The method of claim 1, wherein areas of bubbles displayed on the display unit are proportional to a corresponding amount of grouped data.

4. The method of claim 1, wherein the bubbles are grouped using an initial character of data.

5. The method of claim 1, wherein the bubbles are mapped to a certain key of a key pad.

6. The method of claim 1, further comprising selecting a datum in the data list and displaying detailed information of the datum.

7. The method of claim 1, further comprising, after the step of selecting the bubble, arranging a predetermined number of sub bubbles in a popup window on the display unit, and selecting a sub bubble.

8. The method of claim 1, wherein the data are telephone numbers.

9. A method for searching data in a mobile communication terminal, comprising:
arranging a predetermined number of grouped data in a database as bubbles for display on a display unit;
selecting a bubble;
zooming-in the selected bubble, displaying sub bubbles forming the bubble and arranging the sub bubbles on the zoomed-in bubble,
selecting a sub bubble, zooming-in the selected sub bubble and displaying a character corresponding to the selected sub bubble on a character input window of the display unit; and
displaying a data list including the input character.

10. The method of claim 9, wherein area of the bubbles or sub bubbles in the display unit is proportional to a corresponding amount of grouped data.

11. The method of claim 9, wherein the bubbles are grouped using an initial character of data.

12. The method of claim 1, further comprising selecting a datum in the data list and displaying detailed information of the datum.

13. The method of claim 1, wherein the data are telephone numbers.

14. A mobile communication terminal for searching data, comprising:
a memory including a database storing data;
a controller for searching data;
a bubble processor for arranging a predetermined number of searched grouped data in a database as bubbles on a display, selecting a bubble, outputting a character corresponding to the selected bubble on an input window of the display, and outputting a data list including the input character; and
the display for displaying the character corresponding to the selected bubble on the input window and displaying the data list including the input character.

15. The mobile communication terminal of claim 14, wherein area of the bubbles in the display is proportional to a corresponding amount of grouped data.

16. The mobile communication terminal of claim 14, wherein the bubbles are grouped using an initial character of data.

17. The mobile communication terminal of claim 14, wherein the bubble processor further selects a datum in the data list and displaying detailed information of the datum.

18. The mobile communication terminal of claim 14, wherein the bubble processor, after selecting the bubble, arranges a predetermined number of sub bubbles in a popup window on the display unit, and selects a sub bubble.
